(19) United States
(12) Patent Application Publication
(10) Pub. No.: US 2022/0388252 A1
(43) Pub. Date: Dec. 8, 2022

(54) A CONNECTOR BODY, A STRUCTURE INCLUDING THE CONNECTOR BODY, AND A METHOD OF FORMING THE STRUCTURE

(71) Applicant: SA EXEL INDUSTRIES, Epernay (FR)

(72) Inventors: Casper Louis FREDERIKSEN, Sakskøbing (DK); Lars NEJSUM, Vedbæk (DK)

(73) Assignee: SA EXEL INDUSTRIES, 51200 (FR)

(21) Appl. No.: 17/772,905

(22) PCT Filed: Oct. 28, 2020
(86) PCT No.: PCT/EP2020/080288

§ 371 Date: Apr. 28, 2022

(30) Foreign Application Priority Data
Oct. 30, 2019 (DK) PA 2019 70673

(51) Int. Cl. B29C 65/54; A01M 7/00; B29C 65/48; B29C 65/00; E04C 3/28; F16L 13/10; F16L 13/11; F16B 11/00

(52) U.S. Cl. CPC B29C 65/542; A01M 7/0071; B29C 65/485; B29C 66/1122; B29C 66/5344; B29C 66/7212; B29C 66/72141; E04C 3/28; F16L 13/103; F16L 13/116; F16B 11/008

(57) ABSTRACT

A connector body having a first end portion defining a first end face of the body and an opposite second end portion defining a second end face of the body, the first end portion including a first peripheral groove with a first sealing ring, and the second end portion including a second peripheral groove with a second sealing ring, an intermediate portion of the—body defining a peripheral surface extending between the first sealing ring and the second sealing ring, the peripheral surface to be covered by the retaining glue for bonding the body to the tube, a glue flow passage at the first end portion extending transversally to the first sealing ring, and a glue injection channel extending from the first end portion towards the second end portion and including a glue injection port in the first end portion and a glue ejection port at the peripheral surface.

The present invention relates in particular to light-weight agricultural sprayer booms. Specifically, the invention relates to a connector body for being glued to the inside of a hollow carbon fibre tube forming a two- or three-dimensional light-weight carbon fibre structure defining a sprayer boom section connectable, via the connector body and a connector device, to either a metal boom section or directly to a frame carried by or driven by a tractor or similar vehicle.

When designing and making such sprayer booms it is necessary to take into account the high static and dynamic loads acting as the agricultural sprayer travels across a field. Various attempts have been made to manufacture such sprayer booms in an economical manner. One particular problem resides in the connection between the tubes of the light weight carbon fibre structure and the connector devices. Connecting carbon fibre tubes to each other via a connector body and a connector device using glue applied to the surface of a connector body is known from WO99/49150; however, a problem resides in that glue pre-applied onto this surface may be partially scraped off due to inadvertent contact with the surface of the carbon fibre tube as the connector body is inserted into the carbon fibre tube.

In view of this, an object of the present invention is to provide a connector body using which the aforementioned “scraping off” may be avoided and using which a reliable connection can be established, by allowing a person establishing the glued connection between the carbon fiber tube and the connector body to visibly control the quality of the gluing process.

Then, with the invention and after the connector body has been correctly glued to the carbon fibre tube, a connector device may reliably connect the carbon fibre tube with either another boom section or a frame of the agricultural sprayer, by being connected directly to the connector body.

More specifically, according to the invention a connector body is provided having a first end portion defining a first end face of the connector body and an opposite second end portion defining a second end face of the body, the first end portion including a first peripheral groove with a first sealing ring, and the second end portion including a second peripheral groove with a second sealing ring, an intermediate portion of the connector body defining a peripheral surface extending between the first sealing ring and the second sealing ring, this peripheral surface to be covered by the retaining glue for bonding the connector body to the tube, a glue/air outflow passage at the first end portion extending transversally to the first sealing ring, and a glue injection channel extending from the first end portion towards the second end portion and including a glue injection port in the first end portion and a glue ejection port at the peripheral surface.

The outer contour of the connector body defined by the peripheral surface thereof is normally cylindrical as is the inner contour of the carbon fibre tube into which the connector body is inserted, and the two sealing rings of same dimension serve to correctly align the connector body inside the tube. The glue flow passage may be formed in various ways, such as by machining a surface recess in the connector body transverse to and below the first sealing ring, or forming a shallow, elongated recess on the inside surface of the carbon fibre tube along its length, or a transverse, local depression or recess in the first sealing ring to locally eliminate the seal provided by the first sealing ring. The glue/air outflow passage serves as an air escape during glue injection as well as to signal completion of a gluing filling procedure through the appearance of an excess of glue flowing through the outflow passage towards the first end face.

The invention also relates to a connected structure including the connector body inserted into the hollow carbon fibre tube, wherein a layer of the glue in hardened form fills an annular gap between the peripheral surface of the connector body, the two sealing rings and the inside surface of the hollow carbon fibre tube, and where the glue in the hardened form also fills the glue flow passage and the injection channel. The exact position of the glue ejection port is selected as discussed below such that the entire portion of the annular gap all way from the second sealing ring is filled completely when excess glue appears at the outflow port at the first end face.

Forming the aforementioned connected structure comprises a method also defined in the appended claims, comprising the steps of inserting the connector body of the invention into a hollow carbon fibre tube at a first end thereof, with the first and second sealing rings contacting the carbon fibre tube, and then injecting the glue into the annular gap via the glue injection channel until an amount of the glue exits at the outflow port, which is an indication that the annular gap is completely filled with the glue, at which point the glue injection is stopped.

### BRIEF DESCRIPTION OF THE DRAWINGS

FIG. 1a is a perspective, partial and schematic view of a three dimensional light-weight carbon fibre structure,

FIG. 1b shows, schematically, an agricultural sprayer boom extending from one side of a frame,

FIG. 1c shows highly schematically a connector between the structure of FIG. 1a and a metal structure of the boom of FIG. 1b,

FIG. 1d shows schematically a perspective view of the end portion of a prior art elongated hollow cylindrical carbon fibre tube,

FIG. 2a is a side view of a connector body of the invention, and

FIG. 2b is a cross-sectional view as shown in FIG. 2a.

### DETAILED DESCRIPTION

The invention will now be explained in more detail by reference to an embodiment, and to a use thereof.

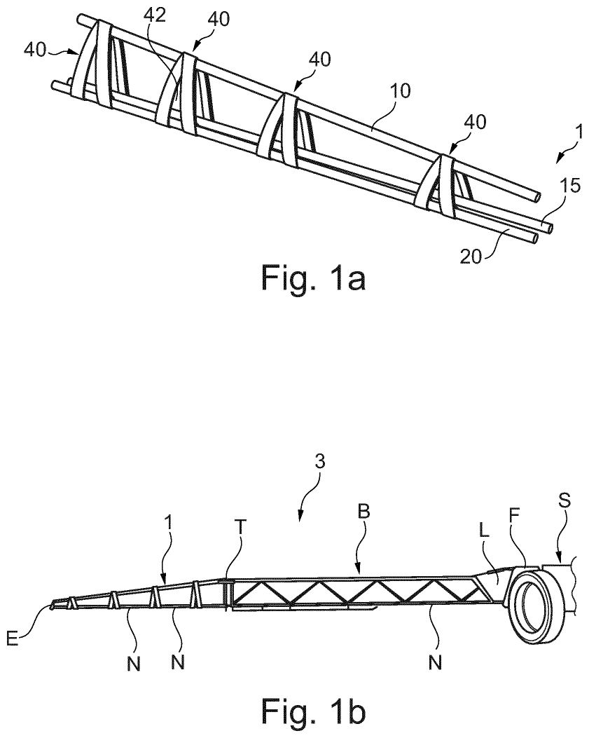

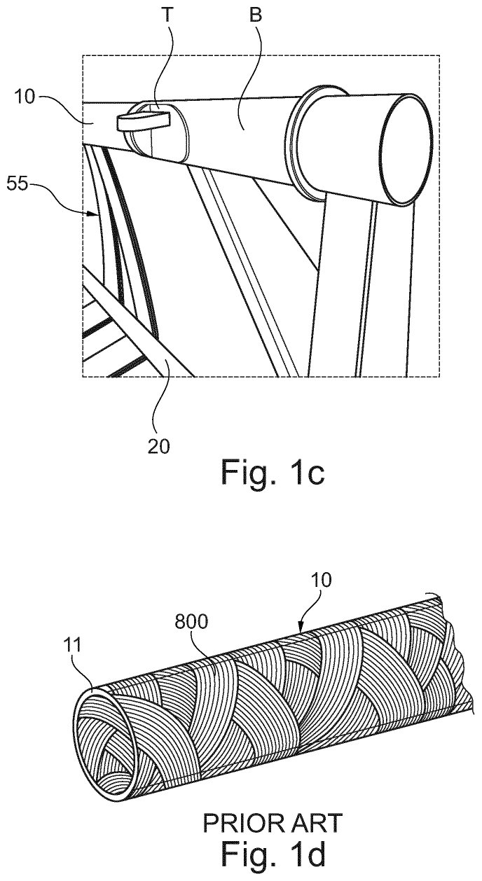

FIG. 1a is a perspective, partial and schematic view of a three dimensional light-weight carbon fibre structure including carbon fibre upper and lower tubes 10, 15, 20 and configured for forming a section 1 of a sprayer boom which is part of an agricultural sprayer.

FIG. 1b shows, in part, an embodiment of such an agricultural sprayer, which also comprises a tractor driven or carried tank S for containing a liquid spraying agent, the tank S being supported by a frame F, normally provided with supporting wheels, of which only one is shown. The sprayer boom normally comprises two similar parts that extend outwards from a respective side of the frame F.

FIG. 1b shows one such part of the boom extending from one side of the frame F and which has an outer end E; for convenience, in the following, the shown boom part will simply be referred to as a boom, and be designated numeral 3.

The boom 3 shown in FIG. 1b carries pipes (not shown) connecting the tank S with nozzles N for delivering the spraying agent and being arranged spaced apart along the length of the boom 3. The spraying agent is, as is conventional, delivered from the tank S using a suitable pump (not shown) mounted on the aforementioned frame F.

The shown boom 3 is, as is conventional for agricultural sprayer booms, supported by the frame F via a link L that allows the boom 3 to be turned into a non-operative position where it extends alongside the tank S in a direction of travel of the agricultural sprayer. In FIG. 1b the boom 3 is shown as being formed by two individual sections, one being the section 1 shown in FIG. 1a and the other one being a relatively heavy three dimensional metal lattice structure B connected at one end to the frame F via the aforementioned link L. The light-weight carbon fibre section 1 which defines the boom outer end E at its one end, is connected with the metal structure B at its other end via at least one connector device T. The lattice structure B may alternatively be a light weight lattice structure, such as a carbon or aluminium lattice structure.

The connector device T is shown highly schematically in FIG. 1c, and is typically a metal body. The connector device T allows for the carbon fibre section 1 to be supported by the metal structure B, and may itself be configured to allow for the light-weight section 1 to be turned relative to the metal structure B to allow for the two structures 1, B to be folded against each other, to reduce the overall length of the boom 3 when in its non-operative position alongside the tank S. Often a connector device T will connect the shown upper tube 10 of the section 1 with an upper lattice member of the metal structure B, while similar connectors will connect each of the shown two lower tubes 15, 20 with respective lower lattice members of the metal structure B.

Where the carbon fibre section 1 is connected directly to the frame F, as where no metal structure B is used, the connector device T may comprise, or be connected to, the aforementioned link L at the frame F. The connector device T may be welded to or otherwise secured to the metal structure B or to the frame F, as the case may be, and have respective end faces 11.

In FIG. 1d is schematically shown a perspective view of the end portion of an elongated hollow cylindrical carbon fibre tube. Such a tube defines each one of the shown elongated tubes 10, 15, 20 that form the three dimensional carbon fibre structure or section 1 wherein the upper tube 10 may preferably converge towards the two lower tubes 15, 20 at the end E of the boom 3. Preferably, the tubes 10, 15, 20 have been made with a length corresponding to that of the carbon fibre section 1

Generally, each elongated tube 10, 15, 20 is a carbon fibre/epoxy tube, that may be formed by spiral winding a carbon fibre string 800 in alternate directions around a mandrel that defines the internal diameter of the tube 10, 15, 20, with the total thickness of the tube 10, 15, 20 being determined by the thickness of the windings. As explained in WO99/49150, such tubes are cured to provide maximum mechanical properties. To allow for subsequent pulling off of the finished tube from the mandrel a slip agent is normally applied to the mandrel.

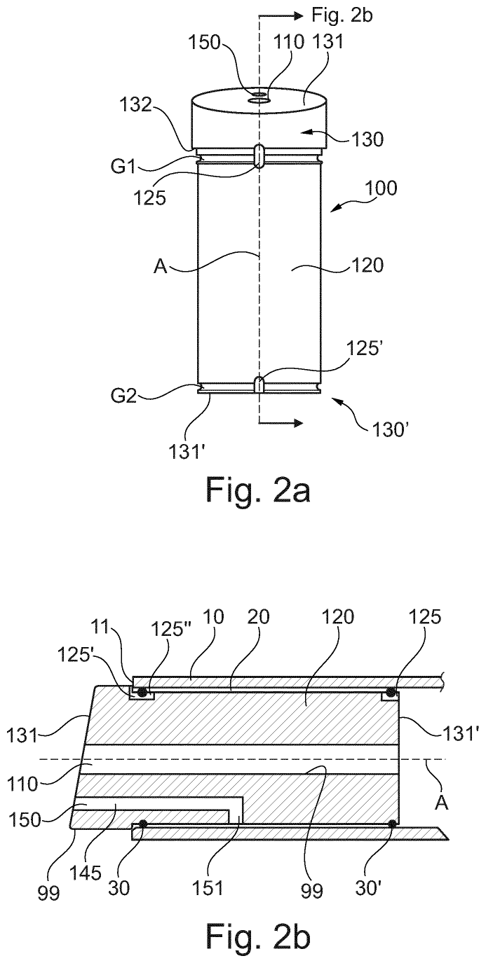

The present invention as claimed herein relates to a connector body 100 as shown in FIGS. 2a and 2b, which connector body 100 has an anchoring portion 99 configured for connecting a respective hollow tube 10, 15, 20 of the carbon fibre section 1 with a connector device T which may on its side either connect with the metal structure B of an agricultural sprayer boom 3, or directly with the aforementioned frame F. For this purpose the connector body 100 is inserted as far into the end of the tube 10 as allowed by a face 132 that is configured to bear against the end face 11 of the tube 10, as shown in FIG. 2b. Glue is then injected to connect the connector body 100 with the inside surface of the tube 10. The glue may be a conventional metal/carbon glue, such as a two-component glue prepared in advance of the gluing procedure, such as the epoxy adhesive system marketed as Spabond™335.

Prior to insertion of the connector body 100 the inside surface of the hollow tube 10, 15, 20 near its end face 11 is normally prepared for the gluing procedure, such as by sanding, to i.a. remove the slip agent mentioned above with reference to FIG. 1d, and to roughen this surface for providing a better adherence of the glue.

An embodiment of the connector body 100 will now be discussed in details with reference to FIGS. 2a and 2b. FIG. 2b is a cross-sectional view as shown in FIG. 2a, to which cross-sectional view sealing rings as discussed below have been added.

As will be understood, the connector body 100 is for glued retaining inside a hollow carbon fibre tube 10, 15, 20. The connector body 100 has a first end portion 130 defining a first end face 131 of the body 100 and an opposite second end portion 130′ that defines a second end face 131′ of the connector body 100. The first end portion 130 includes a first peripheral groove G1 in which has been fitted a first, annular sealing ring 30, normally of an elastomeric material, and the second end portion 130′ includes a second peripheral groove G2 in which a second sealing ring 30′ has been fitted. An intermediate portion, normally of cylindrical shape (as shown), of the body 100 defines a peripheral surface 120 which extends between the two sealing rings 30, 30′. This peripheral surface 120 is to be covered by the retaining glue for the purpose of bonding the connector body 100 to the inside surface of the tube 10. The connector body 100 is dimensioned such that the sealing rings 30, 30′ contact the inside surface of the tube 10, such that a sealed annular gap 20 is defined between the peripheral surface 120 and the inside surface of the tube 10.

A glue/air outflow passage 125 defined by a relatively narrow recess at the first end portion 130 extends below the first sealing ring 30 transversally thereto, being intersected from above by the first groove G1. The glue/air outflow passage 125 has an open glue/air outflow port 125′ at a first end thereof and, at the opposite end, an open glue/air inflow port 125′, located at the peripheral surface 120 to one side of the first sealing ring 30, for glue/air inflow into the glue/air outflow passage 125. In this way, glue and/or air may locally by-pass the seal provided by the first sealing ring 30 by flowing in the glue/air outflow passage 125 from the gap 20, below the sealing ring 30, and exit at the glue/air outflow port 125′ on the other side of the first sealing ring 30.

An internal glue injection channel 145 extends within the connector body 100 from the first end portion 130 towards the second end portion 130′ and includes a glue injection port 150 at the first end face 131 and a glue ejection port 151 located at the peripheral surface 120. The glue injection port 150 preferably is designed for receiving a glue gun or similar device, which may be as shown by numeral 503 in FIG. 5 of WO99/49150. The glue ejection port 151 may as shown be at the end of a transverse bore defining together with a longitudinal bore, that is generally parallel with an axis A of the connector body 100, the glue injection channel 145.

As may be understood, the gap 20 preferably communicates only with the exterior via the glue/air outflow passage 125 and the glue injection channel 145, in that the sealing rings 30, 30′ otherwise seal off the gap 20. A further, similar glue outflow passage 125 may in some cases be provided also at the second end portion 130′ of the body 100; also, additional glue injection channels 145 may be provided, although this is presently not foreseen.

In operation the connector body 100 is inserted into the hollow carbon fibre tube 10 at the tube end face 11, with the first end face 131 accessible at the first end 11 of the tube 10 and with the first and second sealing rings 30, 30′ contacting the inside surface of the carbon fibre tube 10, to provide also a centering of the connector body 100 inside the tube 10. Then glue is injected into the annular gap 20 via the internal glue injection channel 145 until an amount of the glue exits at the outflow port 125′, which is a visual indication that the entire annular gap 20 has been filled and, hence, that an amount of glue has been injected corresponding to the amount that will ensure a safe bonding between the tube 10 and the connector device 100, to ensure that the connection is capable of transmitting expected forces between the tube 10 and a connector device T connected with the connector body 10.

The glue/air inflow port 125″ is preferably located bordering up to the first sealing ring 30, on one side thereof. In the shown embodiment the glue ejection port 151 is located opposite the glue flow passage 125, i.e. to the other side of a longitudinal axis A of the connector body 100. While not shown in the figures the glue ejection port 151 may preferably be located closer to the second end face 131′ than to the first end face 131, or at half of the distance between the first sealing ring 30 and the second sealing ring 30′. The position of the glue ejection port 151 is selected such that glue injected via the glue injection channel 145 will not exit at the outflow port 125′ at the first end face 131 before glue has filled the entire annular gap 20. The flow of glue may only be from the glue ejection port 151 towards the first end face 131, in the case where the glue ejection port 151 is located very close to, or at, the second sealing ring 30′.

Where the glue ejection port 151 is located halfway, or approximately halfway, between the two sealing rings 30, 30′ glue will flow from the glue ejection port 151 in two opposite directions; the exact position of the glue ejection port 151 is preferably selected such that the entire portion of the annular gap 20 all way from the second sealing ring 30′ is filled completely when glue appears at the outflow port 125′ at the first end face 131. Providing a further flow passage 125 at the second end portion 130′ may sometimes be desirable to ensure air is purged from the annular gap 20, in which case the location of the glue ejection port 151 may be selected such that only a little amount of glue, if any exits, at the further passage before glue starts exiting at the glue flow passage at the first end portion 130.

For connecting the aforementioned connector device T with the connector body 100 an anchoring portion for mechanical connection with the connector device T is provided, such as by including an externally threaded portion 99 of the connector body 100, and/or by the connector body 100 including an internal bore 110 extending from the first end face 131 towards the second end portion 130′, the bore 110 comprising a threaded portion 99. The threaded portion 99 is for cooperating with a threaded portion of the connector device T, which may then be screwed into engagement with the threaded portion 99 of the connector body 100. Alternatively, the connector body 100 may comprise a projecting threaded rod, such as for engaging a threaded bore formed in the connector device T.

Although not shown, the glue/air outflow passage 125 may alternatively be a shallow, elongated recess formed on the inside surface of the carbon fibre tube 10 to extend a short distance, such as 1-5 cm, from the end face 11 along the tube 10 length and defining at one end a glue/air inflow port communicating with the gap 20, with its other end providing an open glue/air outflow port at the side of the first sealing ring 30 closer to the first end face 131. Alternatively, the glue flow passage 125 may be a shallow, transverse recess formed locally in the first sealing ring 30 to locally eliminate the seal provided by the first sealing ring 30.

The term “port” as used herein may refer to a simply wall opening or open recess end, without necessarily including any valve structure, as is the case for the shown embodiment.

1. A connector body for glued retaining inside a hollow carbon fiber tube, said connector body comprising:
a first end portion defining a first end face of said connector body;
an opposite second end portion defining a second end face of said connector body;
said first end portion comprising a first peripheral groove with a first sealing ring;
said second end portion comprising a second peripheral groove with a second sealing ring;
an intermediate portion of said connector body defining a peripheral surface extending between said first sealing ring and said second sealing ring, said peripheral surface to be covered by a retaining glue for bonding said connector body to a hollow carbon fiber tube;
a glue/air outflow passage at said first end portion extending transversally to said first sealing ring; and
a glue injection channel extending from said first end portion towards said second end portion and comprising a glue injection port in said first end portion and a glue ejection port at said peripheral surface.

2. The connector body of claim 1, said glue/air outflow passage comprising at one end a glue/air outflow port located on one side of said first sealing ring and a glue/air inflow port located at said peripheral surface on another side of said first sealing ring.

3. The connector body of claim 2, said glue/air inflow port being located at said first sealing ring, said glue ejection port being located closer to said second sealing ring than to said first sealing ring.

4. The connector body of claim 2, a connector body recess forming said glue/air outflow passage, said glue/air outflow passage extending below said first sealing ring.

5. The connector body of claim 1, said glue injection channel extending within said connector body.

6. The connector body of claim 1, said intermediate portion being formed as a circular cylinder.

7. The connector body of claim 1, said glue ejection port being located opposite said glue/air outflow passage.

8. The connector body of claim 1, said peripheral surface being roughened.

9. The connector body of claim 1, said first end portion comprising an anchoring structure for mechanical connection with a connector device.

10. The connector body of claim 9, said anchoring structure defined by a threaded portion of said connector body.

11. The connector body of claim 10, comprising an internal passage extending from said first end face towards said second end portion said internal passage comprising said threaded portion.

12. The connector body of claim 1, wherein said connector body is a metal body.

13. A structure comprising:
a connector body comprising:
a first end portion defining a first end face of said connector body;
an opposite second end portion defining a second end face of said connector body;
said first end portion comprising a first peripheral groove with a first sealing ring;
said second end portion comprising a second peripheral groove with a second sealing ring;
an intermediate portion of said connector body defining a peripheral surface extending between said first sealing ring and said second sealing ring, said peripheral surface to be covered by a retaining glue for bonding said connector body to a hollow carbon fiber tube;
a glue/air outflow passage at said first end portion extending transversally to said first sealing ring; and
a glue injection channel extending from said first end portion towards said second end portion and comprising a glue injection port in said first end portion and a glue ejection port at said peripheral surface;
wherein the structure comprises the connector body being inserted into a hollow carbon fiber tube, wherein a layer of said retaining glue in hardened form fills an annular gap that is between said peripheral surface, said first sealing ring and said second sealing ring and an inside surface of said hollow carbon fiber tube.

14. The structure of claim 13, wherein said retaining glue in hardened form fills said glue/air outflow passage and said glue injection channel.

15. A method of forming a structure comprising:
a connector body comprising:
a first end portion defining a first end face of said connector body;
an opposite second end portion defining a second end face of said connector body;
said first end portion comprising a first peripheral groove with a first sealing ring;
said second end portion comprising a second peripheral groove with a second sealing ring;
an intermediate portion of said connector body defining a peripheral surface extending between said first sealing ring and said second sealing ring, said peripheral surface to be covered by a retaining glue for bonding said connector body to a hollow carbon fiber tube;
a glue/air outflow passage at said first end portion extending transversally to said first sealing ring; and
a glue injection channel extending from said first end portion towards said second end portion and comprising a glue injection port in said first end portion and a glue ejection port at said peripheral surface;
wherein the structure comprises the connector body being inserted into a hollow carbon fiber tube, wherein a layer of said retaining glue in hardened form fills an annular gap that is between said peripheral surface, said first sealing ring and said second sealing ring and an inside surface of said hollow carbon fiber tube;
the method comprising:
inserting said connector body into said hollow carbon fiber tube from a first end thereof, with said first sealing ring and said second sealing ring contacting said carbon fiber tube; and
injecting said retaining glue into said annular gap via said internal glue injection channel until an amount of said retaining glue exits at said outflow port.
